(19) United States
(12) Patent Application Publication
(10) Pub. No.: US 2022/0329199 A1
(43) Pub. Date: Oct. 13, 2022

(54) SOLAR PANEL SUPPORT AND ASSEMBLY COMPRISING THE SOLAR PANEL SUPPORT

(71) Applicant: SUPERSOLA B.V., 's-Gravenhage (NL)

(72) Inventor: Julius Smith, 's-Gravenhage (NL)

(21) Appl. No.: 17/642,370

(22) PCT Filed: Sep. 11, 2020
(86) PCT No.: PCT/NL2020/050562

§ 371 Date: Mar. 11, 2022

(30) Foreign Application Priority Data
Sep. 11, 2019 (NL) 2023809

(51) Int. Cl. H02S 20/30; H02S 40/38; H02S 40/42; H02S 30/10

(52) U.S. Cl. CPC H02S 20/30; H02S 40/38; H02S 40/42; H02S 30/10

(57) ABSTRACT

A solar panel support arranged for supporting a solar panel under an angle (A) relative to a ground surface. The solar panel support including a frame arranged for removably holding the solar panel; a ballast that is removably attached to the frame; a foot arrangement that is connected to the frame and arranged for providing a foot of the foot arrangement in a plurality of angular positions relative to the frame for positioning the frame under a corresponding plurality of angles relative to the ground surface, wherein the foot arrangement at least partly bounds, in use, a space (s) between the ground surface and the frame such that, in use, an air flow (AF) is guided over a side of the frame that is turned away from the ground surface. An assembly including the solar panel support.

According to a first aspect, the present disclosure relates to a solar panel support arranged for supporting a solar panel under an angle relative to a ground surface.

According to a second aspect, the present disclosure relates to an assembly comprising a solar panel support according to the first aspect of the present disclosure and a solar panel.

Solar panels are often mounted on top of a roof of a building, or on the ground, e.g. on a field or other terrain, preferably without too much shadow castings. Usually, a solar panel support is attached to the solar panel to provide the solar panel at an angle with respect to a roof or ground surface, for instance at an angle between 0° and 45°, e.g. between 10° and 40°, such as for instance at an angle of about 35°.

In order to avoid, or at least significantly reduce the risk, that the solar panel may be blown from the roof, or tilted from the ground, in case of strong wind, the solar panel support is often ballasted by several relatively heavy tiles or other solid materials or the solar panel support itself is of a relatively heavy design. Additionally or alternatively, the support can be fixedly attached to the roof, or anchored to the ground, for instance by means of screws or the like.

It will be appreciated that transporting, handling and/or mounting a relatively heavy solar panel support can be disadvantageous. On the other hand, fixedly attaching the support to the roof may be disadvantageous as well since this may damage the roof.

An object of the present disclosure is to provide a solar panel support and an assembly comprising the solar panel support that is relatively practical as regards installation while being relative insensitive to strong wind.

The objective is realised by providing a solar panel support arranged for supporting a solar panel under an angle relative to a ground surface, said solar panel support comprising:
a frame arranged for removably holding said solar panel;
a ballast that is removably attached to said frame; and
a foot arrangement that is connected to said frame and arranged for providing a foot of said foot arrangement in a plurality of angular positions relative to said frame for positioning said frame under a corresponding plurality of angles relative to said ground surface.

By providing a removable ballast the solar panel support may be handled and brought to a desired location without the need for handling a relative large weight corresponding to the weight of the solar panel support including the ballast. In other words, the solar panel support may advantageously be provided at a desired location by separately transporting the ballast.

Moreover, by attaching the ballast to the frame and allowing the frame to be positioned under an angle relative to the ground surface, by the foot arrangement, a relative compact solar panel support may be realised that allows for a relative practical transportation thereby beneficially contributing to a practical installation.

In addition, the foot arrangement contributes to a practical installation in that a single solar panel support design may be used for varies angles relative to the ground surface. The present disclosure at least partly relies on the insight that the known solar panel supports are generally arranged for providing a solar panel in a single angle relative to the ground surface or require a relative time consuming adjustment of the construction for providing the solar panel under a predetermined angle relative to the ground surface.

By providing the ballast to the frame, the ballast is also provided under an angle relative to the ground surface when providing the frame under a predetermined angle to the ground surface. Providing the ballast in this manner realizes a pressure force to be exerted, via the frame and the foot to the ground surface. This is beneficial for realising a relative strong construction that has a relative high resistance to air flow.

Preferably, said foot arrangement at least partly bounds, in use, a space between said ground surface and said frame such that, in use, an air flow is guided over a side of said frame that is turned away from said ground surface. This is beneficial for allowing a relative practical installation of the solar panel support while being relative insensitive to strong wind.

In an embodiment of the solar panel support, said solar panel support comprises a locking arrangement, wherein in a first condition of said locking arrangement said ballast may be removed from said frame and in a second position of said locking arrangement said ballast is locked to said frame. This is beneficial for avoiding, or at least significantly reducing the risk of, unintended removal of the ballast from the frame.

It is advantageous if said foot is thermally coupled to said solar panel and wherein said foot is arranged as a heat sink for transferring, in use, heat away from said solar panel. This is beneficial for realising or maintaining relative favourable conditions to the solar panel.

It is beneficial if said foot is provided with an electrical connector that is communicatively coupled to said solar panel for transferring energy, generated by said solar panel, away from said solar panel.

Preferably, said ballast comprises at least one of a refillable tank and a battery. A refillable tank, also referred to as a ballast reservoir, may for instance be arranged for holding a pourable ballast, such as a liquid, in particular water, sand or gravel. This allows for filling the tank at the installation location. As a result, the ballast can be provided on location and thus for instance does not need to be stored and/or transported together with the frame, for example as water can be discarded at or near the place where the assembly is located.

In an embodiment of the solar panel support, said ballast comprises said battery and said frame is provided with a battery connector arranged for electrically connecting said battery to said solar panel for storing energy, generated by said solar panel, in said battery.

Preferably, said frame comprises a removable frame element, wherein in a removed condition of said removable frame element said solar panel may be provided in said frame and in a assembled condition of said removable frame element said solar panel is locked to said frame.

It is advantageous if said frame, said ballast and/or said foot arrangement are provided with a recess for allowing a constructor to grasp a said solar panel support.

Preferably, said ballast comprises a plurality of sub-ballasts that each are removably attached to said frame.

According to the second aspect, the present disclosure relates to an assembly comprising a solar panel support according to the first aspect of the present disclosure and said solar panel, wherein said frame is holding said solar panel.

Embodiments of the assembly correspond to embodiments of the solar panel support according to the first aspect of the present disclosure. The advantages of the assembly correspond to the advantages of the solar panel support according to the first aspect of the present disclosure presented previously.

The present disclosure will now be explained by means of a description of a preferred embodiment of a solar panel support and an assembly comprising the solar panel support, in which reference is made to the following schematic figures, in which:

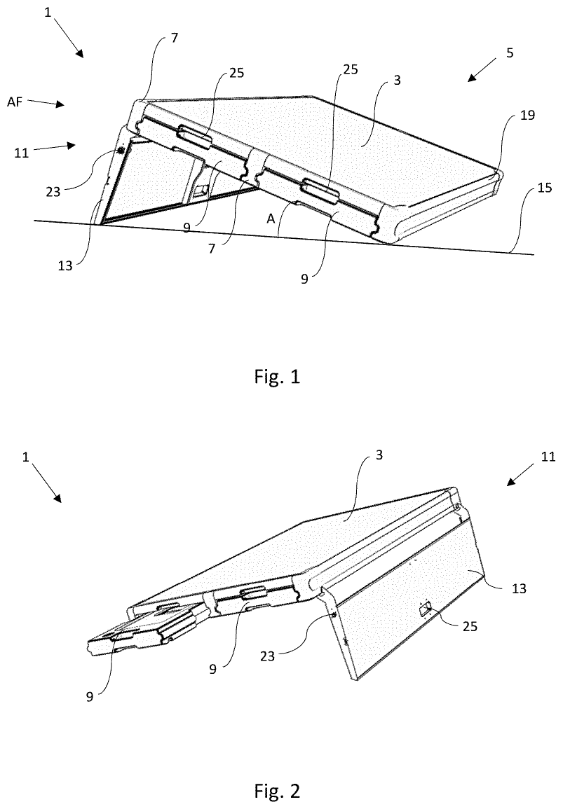

FIGS. 1-2: perspective views of an assembly according to the present disclosure are shown;

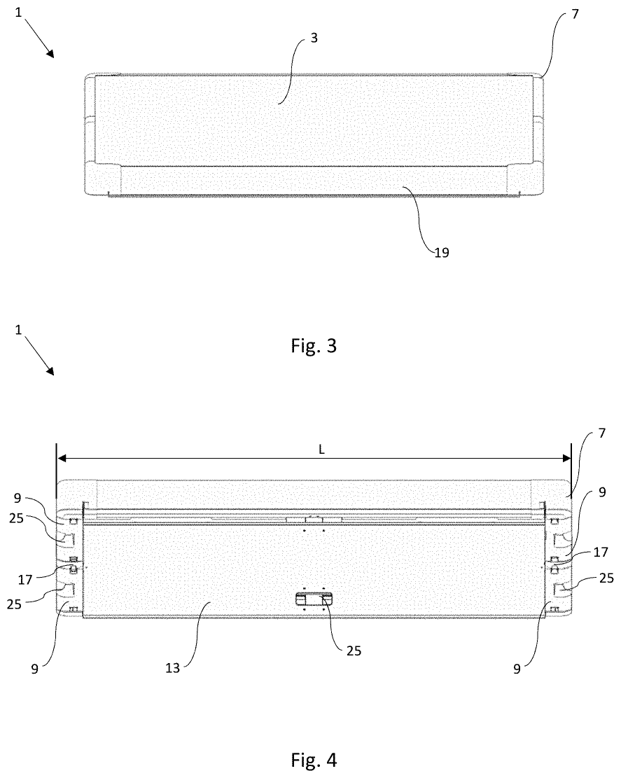

FIG. 3: a front view of the assembly from FIGS. 1 and 2 is shown;

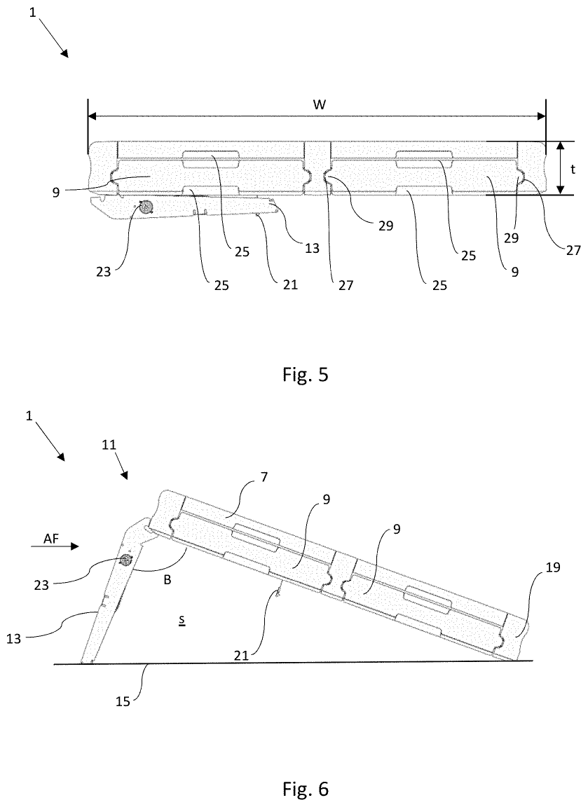

FIG. 4: a back view of the assembly from FIGS. 1 and 2 is shown;

FIGS. 5-6: side views of the assembly from FIGS. 1 and 2 are shown;

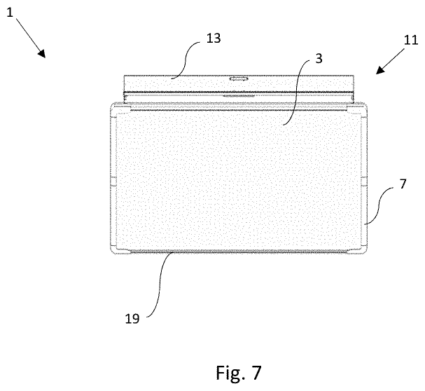

FIG. 7: a top view of the assembly from FIGS. 1 and 2 is shown.

Assembly 1 comprises a solar panel 3 and a solar panel support 5. The solar panel 3 may be arranged to absorb light, in particular sun rays, as a source of energy for generating electricity or heating. Advantageously, the solar panel may be a photovoltaic panel or so-called PV panel, which may preferably comprise photovoltaic cells for the conversion of light into electricity. However, alternative solar panel designs are possible, for instance solar panels comprising photo-electrochemical cells. In embodiment, such as the shown embodiment, the solar panel 3 may be a substantially rectangular solar panel, for example having a width between 50 cm and 150 cm, preferably between 80 cm and 120 cm, such as for instance about 100 cm, and/or having a length between 50 cm and 250 cm, preferably between 150 cm and 170 cm, such as for instance about 165 cm. Preferably the solar panel 3 can be relative thin, e.g. having a thickness of between 0.5 cm and 5 cm, preferably between 3.5 cm and 4.5 cm.

The solar panel support 5 comprises a frame 7 that is arranged for holding the solar panel 3. The frame 7 comprises frame parts that form a rectangular frame. The frame elements are provided with a receiving space (not shown) for receiving a part of the solar panel 3. In other words, the frame elements are arranged to hold a side of the solar panel 3. The frame 7 comprises a removable frame element 19. In a situation wherein the removable frame element 19 is removed, the solar panel 3 may be provided in said frame 7. After the solar panel 3 is provided in the frame 7, the solar panel 3 may be locked to said frame 7 by attaching said frame element 19 to said frame 7.

The solar panel support 5 further comprises a ballast 9 that is removably attached to the frame 7. The ballast 9 is provided as four sub-ballasts that each may be removed and attached to the frame 7. The four sub-ballasts comprise three refillable water tanks and a battery. In an alternative embodiment the four sub-ballasts comprises two refillable water tanks and two batteries. The frame 7 is provided with elongated receiving spaces 27 for slidingly receiving the sub-ballasts. To this end the sub-ballasts are provided with elongated protrusions 29 that are arranged for being received in an elongated receiving space 27 for realising a form-lock connection between the sub-ballast 9 and the frame 7. The sub-ballasts may be locked to the frame 7 by a locking arrangement 17. The locking arrangement 17 may be brought in at least a first condition and a second condition. In the first condition of the locking arrangement 17 a sub-ballast 9 may be removed from the frame 7. In the second position of the locking arrangement 17 a sub-ballast 9 is locked to said frame 7. The ballast 9 is provided such that the ballast 9 extends along a lower side of the solar panel 3 for realising a frame 7 that has a relative small thickness t as compared to the length L and the width W of the frame 7. The length L and the width W of the frame 7 are predominantly determined by length and width of the solar panel 3. The frame 7 is provided with a battery connector (not shown) arranged for electrically connecting the battery forming a sub-ballast 9 to the solar panel 3 for storing energy, generated by said solar panel 3, in said battery.

The solar panel support 5 is further provided with a foot arrangement 11 that is connected to the frame 7. The foot arrangement 11 comprises a foot 13 that is pivotably coupled to the frame 7 for allowing the foot 13 to pivot about a pivot axis for allowing said foot 13 to enclose an angle B with said frame 7 thereby allowing the foot 13 to be brought in a plurality of angular positions relative to the frame 7. In other words, the foot 13 may be rotated relative to the frame 7 for allowing the frame 7 to be positioned in a plurality of angles A relative to the ground surface 15. A foot blocking arrangement 21 of the solar panel support 5 is arranged for blocking pivoting of the foot 13 when the foot 13 is in a retracted position as shown in FIG. 5. The foot blocking arrangement 21 may be actuated for allowing said foot 13 to be pivoted out of the retracted position. The frame 5, ballast 9 and the foot arrangement 11 are provided with recesses 25 for allowing a constructor to grasp the solar panel support 5.

The foot 13 is thermally coupled to said solar panel 3 and preferably made of a material having a relative high thermal conductivity, such as aluminium for transferring, in use, heat away from said solar panel 3. In an embodiment of the solar panel support 5, the solar panel support 5 is provided with a converter for converting energy generated by said solar panel 3. Advantageously, the converter and any further electronics that may generate heat are thermally connected to the foot 13 for transferring the heat away from the solar panel 5 and the converter.

The foot arrangement 11 at least partly bounds, in use, a space s between said ground surface 15 and said frame 7. The foot 13 of the foot arrangement 11 is arranged for guiding an air flow AF in a direction indicated in FIG. 6 over an upper side of the foot 13 and the frame 7. The air flow AF exerts a force on the foot 13 in a direction such that the solar panel support 5 is pressed against the ground surface 15. An air flow opposite to the air flow AF exerts a force on the solar panel 3 in a direction such that the solar panel support 5 is pressed against the ground surface 15. An air flow that is relatively parallel to the ground surface 15 and in a direction perpendicular to the direction of the air flow AF shown in FIG. 6 may be prevented from entering the space s by providing a cover (not shown) arranged for avoiding an air flow to enter the space s.

The foot 13 is provided with an electrical connector 23 that is communicatively coupled to said solar panel 3 for transferring energy, generated by said solar panel 3, away from said solar panel 3. In an embodiment of the solar panel support 5, the electrical connector 23 may be a power socket arranged to provide for interlinking multiple assemblies 1 or to directly provide an electricity user of electricity.

1. A solar panel support arranged for supporting a solar panel under an angle relative to a ground surface, said solar panel support comprising:
a frame arranged for removably holding said solar panel;
a ballast that is removably attached to said frame;
a foot arrangement that is connected to said frame and arranged for providing a foot of said foot arrangement in a plurality of angular positions relative to said frame for positioning said frame under a corresponding plurality of angles relative to said ground surface, wherein said foot arrangement at least partly bounds, in use, a space (s) between said ground surface and said frame such that, in use, an air flow (AF) is guided over a side of said frame that is turned away from said ground surface.

2. The solar panel support according to claim 1, wherein said solar panel support comprises a locking arrangement, wherein in a first position of said locking arrangement said ballast may be removed from said frame and in a second position of said locking arrangement said ballast is locked to said frame.

3. The solar panel support according to claim 1, wherein said foot is thermally coupled to said solar panel and wherein said foot is arranged as a heat sink for transferring, in use, heat away from said solar panel.

4. The solar panel support according to claim 1, wherein said foot is provided with an electrical connector that is communicatively coupled to said solar panel for transferring energy, generated by said solar panel, away from said solar panel.

5. The solar panel support according to claim 1, wherein said ballast comprises at least one of a refillable tank and a battery.

6. The solar panel support according to claim 5, wherein said ballast comprises said battery and said frame is provided with a battery connector arranged for electrically connecting said battery to said solar panel for storing energy, generated by said solar panel, in said battery.

7. The solar panel support according to claim 1, wherein said frame comprises a removable frame element, wherein in a removed condition of said removable frame element said solar panel may be provided in said frame and in a assembled condition of said removable frame element said solar panel is locked to said frame.

8. The solar panel support according to claim 1, wherein said frame, said ballast and/or said foot arrangement are provided with a recess for allowing a constructor to grasp said solar panel support.

9. The solar panel support according to claim 1, wherein said ballast comprises a plurality of sub-ballasts that each are removably attached to said frame.

10. An assembly comprising a solar panel support according to claim 1, wherein said frame is holding said solar panel.
